(19) United States
(12) Patent Application Publication
(10) Pub. No.: US 2020/0029416 A1
(43) Pub. Date: Jan. 23, 2020

(54) PLASMA TORCH EXCITATION DEVICE

(71) Applicant: Orient Service Co., Ltd., Taipei (TW)

(72) Inventor: WU-YU FONG, TAIPEI (TW)

(21) Appl. No.: 16/122,824

(22) Filed: Sep. 5, 2018

(30) Foreign Application Priority Data
Jul. 17, 2018 (TW) 107124661

(51) Int. Cl. H05H 1/38; H05H 1/28

(52) U.S. Cl. CPC H05H 1/38; H05H 2001/3478; H05H 1/28

(57) ABSTRACT

A plasma torch excitation device includes an electrode core frame having a chamber; an electrode implanted in the chamber to form a gas collecting conduit surrounding between the electrode and a wall of the chamber; and an electrode housing fixed at a bottom end of the electrode core frame, the electrode housing having a core bore, the inner end of the core bore communicating with the gas collecting conduit, the outer end serving as a blasting port of the plasma torch. The electrode has an electric ion projecting end, the electric ion projecting end is adjacent to the inner end of the core bore, and a conical bore wall is formed between the inner end and the outer end of the core bore, the conical bore wall is formed by the inner end gradually expanding to the outer end. It can solve the conventional problems of well-known plasma torches, such as, limitation of flame temperature and flame length due to shortness of the core bore.

### FIELD OF THE INVENTION

The present invention relates to a plasma torch generated by exciting an electric ion by an electrode, and more particularly to a plasma torch excitation device.

### DESCRIPTION OF RELATED ART

A plasma torch is a high-temperature flame capable of generating a beam of directed plasma jets. The temperature of the plasma torch can be as high as 3000° C.-10000° C., so it is commonly used in material processing, welding, waste treatment, ceramics cutting, metal cutting and semiconductor exhaust gas sintering.

Referring to FIG. 1 which discloses a technique for generating a plasma torch, which comprises applying a DC, AC or RF power source of the current of a voltage of tens of volts (V) and several hundred amps (A) between an electrode 10a of an anode and an electrode housing 20a of a cathode. A gas collecting conduit 21 is formed between the electrode 10a and the electrode housing 20a, and a gas set such as He, Ar, N₂ or O₂ is introduced into the gas collecting conduit 21. The gas is excited between the electrode 10a and the electrode housing 20a to generate electric ions (e−) collided and jittered. At the same time as the electrical ions (e−) are collided and jittered, the pressurized gas in the gas collecting conduit 21 push the gas carried electric ions (e−) out of the electrode housing 20a to form a plasma torch that is externally jetted.

Further, the electrode housing 20a generally has a core bore 22a, and the gas collecting conduit 21 in the electrode housing 20a communicates with the outside through the core bore 22a. The gas in the gas collecting conduit 21 forms electricity jet, i.e. plasma torch, through the core bore 22a to be jetted to the outside. The bore wall of the core bore 22a provides excited electric ion (e−) collision and jump of the electrode 10a to become an electric field.

However, in the prior arts, the core bore 22a is mostly a short circular bore wall or a conical bore wall to provide the area of the ion (e−) collision and the distance of the jump to be too small or too short. In other words, under certain conditions of the power supply, the electric field generated by the core bore 22a of the electrode housing 20a in the prior arts is too small, so that the flame temperature and the flame length of the plasma torch are limited. In addition to affecting the service life of the electrode housing 20a, the ability to utilize a flame to sinter harmful substances in the exhaust gas, such as in a semiconductor exhaust gas treatment process, is also affected.

Since the flame temperature of the plasma torch is extremely high, the water channel 23 is generally opened in the existing electrode housing 20a, and water circulation is introduced into the water channel 23 to cool the temperature of the electrode housing 20a to avoid being subjected to the heat conduction of the flame temperature of the plasma torch, thereby affecting the service life of the electrode housing 20a. However, the structural design of the existing electrode housing 20a for water circulation for heat exchange is not ideal, which is one of the reasons for affecting the service life of the electrode housing 20a.

### SUMMARY OF THE INVENTION

In view of this, the present invention aims to improve the arrangement environment between the electrode, the electrode housing and the gas collecting conduit in the electric field, and further provides a plasma torch excitation device.

In a preferred implementation of the present invention, the technical means of the present invention is to provide a plasma torch excitation device comprises:
an electrode core frame having a hollow chamber;
an electrode implanted in the chamber to form a gas collecting conduit surrounding between the electrode and a wall of the chamber; and
an electrode housing fixed at a bottom end of the electrode core frame, the electrode housing having a core bore having an inner end and an outer end, the inner end communicating with the gas collecting conduit, the outer end serving as a blasting port of the plasma torch;
wherein the electrode has an electric ion projecting end, the electric ion projecting end is adjacent to the inner end of the core bore, and a conical bore wall is formed between the inner end and the outer end of the core bore, the conical bore wall is formed by the inner end gradually expanding to the outer end, and the conical bore wall is expanded to have an aperture of the outer end which is smaller than depth of the conical bore wall.

In a further implementation of the present invention, the inner end of the core bore further comprises a circular bore wall extending from the conical bore wall, and the electric ion projecting end is adjacent to the circular bore wall.

In a further implementation of the present invention, the outer core cover of the electrode housing is provided with an electrode core seat such that a water cavity is formed between the electrode housing and the electrode core seat. The electrode core seat is provided with an inlet pipe and an outlet pipe connected to the water cavity. An outer wall of the electrode housing is formed in a fragment shape.

In a further implementation of the present invention, the electrode core frame is provided with an intake pipe for guiding gas into the gas collecting conduit, and the gas in the intake pipe is sequentially passed through the gas collecting conduit and pressurized then flows out through the core bore. The gas is one of He, Ar, N₂ and O₂.

In a further implementation of the present invention, the electrode core seat is disposed on a semiconductor exhaust gas treatment tank, and a reaction compartment is formed in the semiconductor waste gas treatment tank, the electrode housing serving as an outer end of a plasma torch blasting port is implanted in the reaction compartment. The semiconductor exhaust gas treatment tank is further provided with at least one exhaust gas introduction pipe, and one end of the exhaust gas introduction pipe is implanted in the reaction compartment. The top of the semiconductor exhaust gas treatment tank is provided with a head cover, and the electrode core seat and the exhaust gas introduction pipe are disposed on the head cover at intervals.

According to the above technology, the technical effect that can be produced by the present invention is that the area of the electric ion (e−) collision and the distance of the jump are larger and longer than those of the conventional core bore by the conical bore wall with the core bore length and depth so that the electric field of the core bore of the electrode housing become larger and the flame temperature and flame length of the plasma torch can be effectively improved.

The specific implementation details of the above technical means and their production performance will be described with reference to the following embodiments and drawings.

### BRIEF DESCRIPTION OF THE DRAWINGS

FIG. 1 is a cross-sectional view of a conventional plasma torch excitation device;

FIG. 2 is a cross-sectional view of the plasma torch excitation device of the present invention;

FIG. 3 is a cross-sectional view taken along line A-A of FIG. 2 of the present invention;

FIG. 4 is a schematic view of the operation of FIG. 2 of the present invention;

FIG. 5 is a cross-sectional view showing the arrangement of the plasma torch excitation device of the present invention in a semiconductor exhaust gas treatment tank.

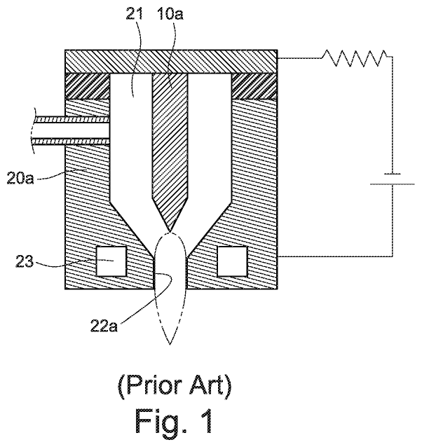

### DETAILED DESCRIPTION OF THE PREFERRED EMBODIMENT

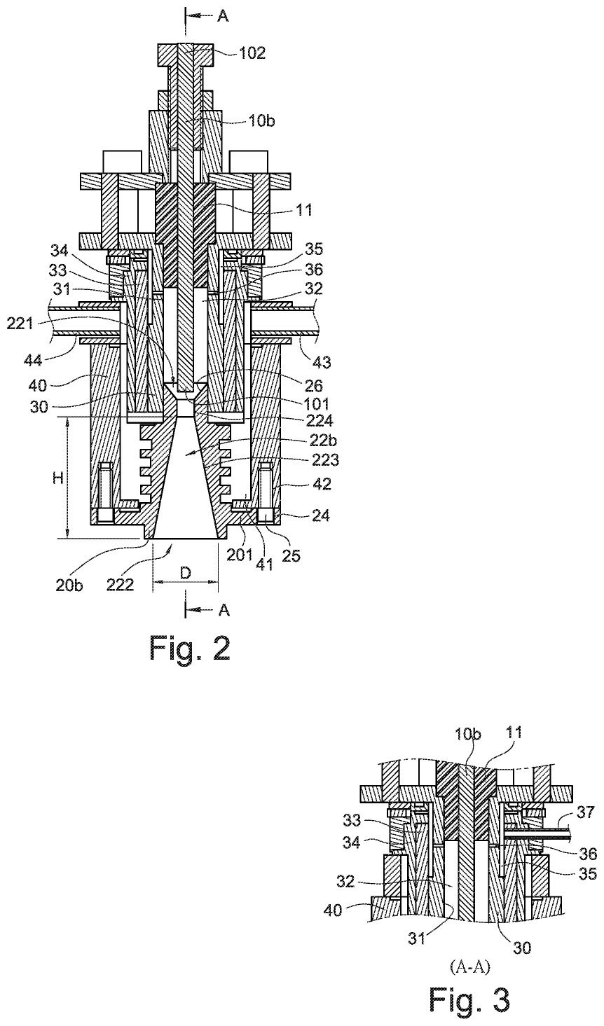

First, please refer to FIG. 2 and FIG. 3 together to disclose a preferred embodiment of a plasma torch excitation device according to the present invention. The plasma torch excitation device comprises an electrode core frame 30 and an electrode 10b and an electrode housing 20b.

The electrode core frame 30 is generally formed in the form of a seat tube, and the electrode core frame 30 has a hollow chamber 31. The electrode 10b is implemented in the form of a bar made of a conductive metal so that the electrode 10b has an electric ion projecting end 101 and a connecting terminal 102. The electrode 10b is centered by an insulating sleeve 11 to be fixed on the electrode core frame 30, and enables the electric ion projecting end 101 of the electrode 10b to be implanted in the chamber 31, thereby forming a gas collection conduit 32 surrounding between the surrounding wall surfaces of the electrode 10b and the chamber 31. The connecting terminal 102 of the electrode 10b protrudes from the electrode core frame 30 to connect to the power source.

The electrode housing 20b is made of a conductive metal and is fixed to the bottom end of the electrode core frame 30. The electrode housing 20b has a core bore 22b having an inner end 221 and an outer end 222. The inner end 221 is connected to the gas collecting conduit 32, and the outer end 222 serves as a flame jetting port of the plasma torch. The electric ion projecting end 101 of the electrode 10b is operatively located adjacent the inner end 221 of the core bore 22b.

Further, the core bore 22b comprises a conical bore wall 223 formed between the inner end 221 and the outer end 222. The conical bore wall 223 is formed by the inner end 221 gradually expanded to the outer end 222 to form. The aperture D of the outer end 222 formed by expanding from the inner end 221 is smaller than the depth H of conical bore wall 223 (as shown in FIG. 2). In this way, the area of the collision and the jump distance of electric ions (e−) on the conical bore wall 223 of the core bore 22b are relatively larger than those of the conventional core bores. The above-mentioned confinement of aperture D<depth H is helpful for facilitating increase of the length of the flame generated by the plasma torch.

The inner end 221 of the core bore 22b further comprises a circular bore wall 224 extending from the conical bore wall 223, and the electric ion projecting end 101 of the electrode 10b is adjacent to the circular bore wall 224. In addition, the electrode housing 20b is further formed with a diversion hole 26 for connecting to the inner end 221 of the core bore 22b (that is, the circular bore wall 224). The inner end 221 of the core bore 22b (that is, the circular bore wall 224) is connected to the gas collecting conduit 32 via the diversion hole 26. The diversion hole 26 can guide the gas in the gas collecting conduit 32 to smoothly flow into the core bore 22b. As can be seen from the above, the circular bore wall 224 and the diversion hole 26 are a part of the inner end 221 of the core bore 22b and are described. Referring to FIG. 3, the outer cover of the electrode core frame 30 is provided with a bearing sleeve 33, and an annular guiding groove 35 is formed between the electrode core frame 30 and the bearing sleeve 33. On the wall 31 of the chamber 31 of the electrode core frame 30 a plurality of guiding holes 36 for communicating with the gas collecting conduit 32 and the annular guiding groove 35 are formed. In other words, a gas flow passage is formed between the annular guiding groove 35, the guiding hole 36 and the gas collecting conduit 32. The annular guiding groove 35 is in communication with a gas inlet pipe 37 for introducing a gas such as He, Ar, N₂ or O₂, such that the gas flows along the gas flow passage formed between the annular guiding groove 35 and the guiding hole 36 and the gas collecting conduit 32, and the gas flows toward the core bore 22b, and then flows out through the core bore 22b.

Referring to FIG. 2 and FIG. 3 illustrating the outer cover of the electrode housing 20b is provided with an electrode core seat 40. The electrode core seat 40 is fixed to the bottom of the electrode core frame 30 via a bearing seat 34 and is further covered on the outer periphery of the electrode housing 20b. A water cavity 41 is formed between the electrode housing 20b and the electrode core seat 40. A water circulation can be introduced into the water cavity 41 for cooling the temperature of the electrode housing 20b. The electrode core seat 40 is formed with a plurality of threaded holes 42. The outer wall of the electrode housing 20b is formed with a ring portion 201, and the ring portion 201 is provided with a fixing hole 24 corresponding to the plurality of threaded holes 42. The electrode housing 20b and the electrode core seat 40 are fixedly coupled to each other by the screw 25 being screwed into the threaded holes 42 through the fixing hole 24. The electrode core seat 40 is disposed with an inlet pipe 43 and an outlet pipe 44 for communicating with the water cavity 41 so that water can flow from the inlet pipe 43 into the water cavity 41, and then out of the outlet pipe 44. The water flows out to form a water circulation to cool the temperature of the electrode housing 20b. Further, the outer wall of the electrode housing 20b is formed into a shape of a fragment which can increase the contact area of the electrode housing 20b with water, thereby improving the heat exchange effect of water when cooling the electrode housing 20b.

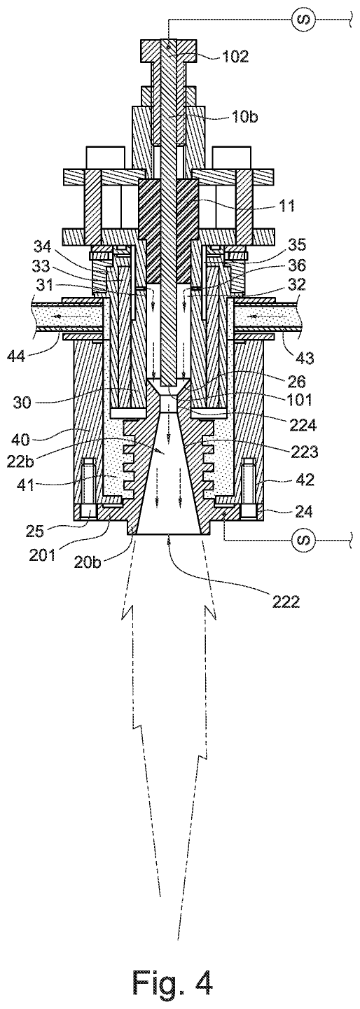

Please refer to FIG. 4, which illustrates that the positive electrode and the negative electrode of the power source are respectively connected to the connecting terminal 102 of the electrode 10b and the electrode housing 20b to be energized. The electrode 10b and the conical bore wall 223 of the electrode housing 20b are excited to generate the collision and the jump of the electric ions (e−) so that an electric field for generating electric ions (e−) is generated in the core bore 22b. At the same time, the gas, such as He, Ar, N₂, O₂, is introduced into the gas collection conduit 32 and is pressurized, and the electric ions (e−) are pushed out from the outer end 222 of the core bore 22b, thereby forming a plasma torch flame of the external jet. In this state, the temperature of the electrode housing 20b can be lowered by the circulating water flowing from the inlet pipe 43 into the water cavity 41 and then flowing out of the outlet pipe 44, thereby preventing the electrode housing 20b from being heated by the torch flame so as to increase durable service life. In particular, the fragment-shaped outer wall of the electrode housing 20b provides a large heat exchange area, which facilitates heat exchange with water in the water cavity 41, and can effectively avoid over-heating of the electrode housing 20b.

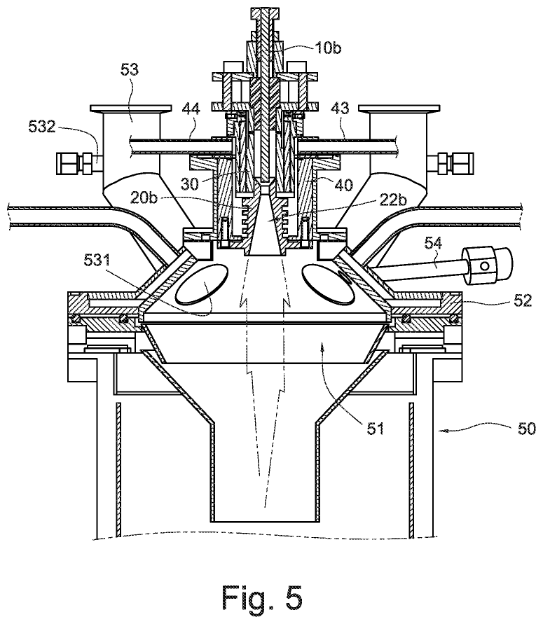

Please refer to FIG. 5, which illustrates that the plasma torch excitation device of the present invention is disposed on a semiconductor exhaust gas treatment tank 50. A reaction compartment 51 is formed in the semiconductor exhaust gas treatment tank 50, and the semiconductor process exhaust gas is first introduced. Inside the reaction compartment 51, sintering is then carried out at the high temperature provided by the plasma torch. The top cover of the semiconductor exhaust gas treatment tank 50 is provided with a head cover 52 which is disposed at the top of the semiconductor exhaust gas treatment tank 50. The electrode core seat 40 is disposed on the head cover 52 so that the electrode housing 20b used as the outer end of the plasma torch blasting port is implanted into the reaction compartment 51. The plasma torch formed by the jet flow of the core bore 22b of the electrode housing 20b enters the reaction compartment 51 to sinter the semiconductor process exhaust gas, and the semiconductor process exhaust gas, for example. After the high-temperature sintering reaction harmful NF₃, SF₆, CF₄, C₃F₈, and C₂F₆ and other Fluorinated Compounds (PFC) gases in the semiconductor process exhaust gas can be decomposed into harmless fluoride ions to achieve the purpose of purifying exhaust gas.

The semiconductor exhaust gas treatment tank 50 is configured to have at least one exhaust gas introduction pipe 53 of a semiconductor process exhaust gas, and the exhaust gas introduction pipe 53 is implanted at one end of the reaction compartment 51 to form an outlet 531 through which the exhaust gas introduction pipe 53 is formed. The exhaust gas introduction pipe 53 is in communication with the reaction compartment 51 via the outlet 531. Further, the exhaust gas introduction pipe 53 and the electrode core seat 40 are disposed on the head cover 52 at intervals so that the exhaust gas introduction pipe 53 can guide the exhaust gas into the reaction compartment 51 from the top of the semiconductor exhaust gas treatment tank 50. In addition, the exhaust gas introduction pipe 53 is provided with an intake pressure detecting port 532. The intake pressure detecting port 532 can detect the pressure and the flow rate of the semiconductor process exhaust gas flowing into the reaction compartment 51 in the exhaust gas introducing pipe 53 by the instrument. The head cover 52 is further provided with an ultraviolet detecting port 54. The ultraviolet detecting port 54 can detect the working condition of the plasma torch by the ultraviolet detecting device.

The above embodiments are merely illustrative of preferred embodiments of the invention, but are not to be construed as limiting the scope of the invention. It should be noted that various modifications and improvements may be made without departing from the spirit and scope of the invention. Therefore, the present invention should be based on the content of the claims defined in the scope of the patent application.

We claim:

1. A plasma torch excitation device comprising:
an electrode core frame having a hollow chamber;
an electrode implanted in the chamber to form a gas collecting conduit surrounding between the electrode and a wall of the chamber; and
an electrode housing fixed at a bottom end of the electrode core frame, the electrode housing having a core bore having an inner end and an outer end, the inner end communicating with the gas collecting conduit, the outer end serving as a blasting port of the plasma torch;
wherein the electrode has an electric ion projecting end, the electric ion projecting end is adjacent to the inner end of the core bore, and a conical bore wall is formed between the inner end and the outer end of the core bore, the conical bore wall is formed by the inner end gradually expanding to the outer end, and the conical bore wall is expanded to have an aperture of the outer end which is smaller than depth of the conical bore wall.

2. The plasma torch excitation device as claimed in claim 1, wherein the inner end of the core bore further comprises a circular bore wall extending from the conical bore wall, and the electric ion projecting end is adjacent to the circular bore wall.

3. The plasma torch excitation device as claimed in claim 1, wherein the outer core cover of the electrode housing is provided with an electrode core seat such that a water cavity is formed between the electrode housing and the electrode core seat.

4. The plasma torch excitation device as claimed in claim 3, wherein the electrode core seat is provided with an inlet pipe and an outlet pipe connected to the water cavity.

5. The plasma torch excitation device as claimed in claim 3, wherein an outer wall of the electrode housing is formed in a fragment shape.

6. The plasma torch excitation device as claimed in claim 1, wherein the electrode core frame is provided with an intake pipe for guiding gas into the gas collecting conduit, and the gas in the intake pipe is sequentially passed through the gas collecting conduit and pressurized then flows out through the core bore.

7. The plasma torch excitation device as claimed in claim 6, wherein the gas is one of He, Ar, N₂ and O₂.

8. The plasma torch excitation device as claimed in claim 1, wherein the electrode core seat is disposed on a semiconductor exhaust gas treatment tank, and a reaction compartment is formed in the semiconductor waste gas treatment tank, the electrode housing serving as an outer end of a plasma torch blasting port is implanted in the reaction compartment.

9. The plasma torch excitation device as claimed in claim 8, wherein the semiconductor exhaust gas treatment tank is further provided with at least one exhaust gas introduction pipe, and one end of the exhaust gas introduction pipe is implanted in the reaction compartment.

10. The plasma torch excitation device as claimed in claim 9, wherein the top of the semiconductor exhaust gas treatment tank is provided with a head cover, and the electrode core seat and the exhaust gas introduction pipe are disposed on the head cover at intervals.
